(19) United States
(12) Patent Application Publication
(10) Pub. No.: US 2008/0065467 A1
(43) Pub. Date: Mar. 13, 2008

(54) METHOD FOR DETERMINING SUPPLY/DEMAND INEQUITIES FOR JOBS

(75) Inventor: K. D. Nyegaard, Poway, CA (US)

Correspondence Address: BUCHANAN, INGERSOLL & ROONEY LLP, P.O. BOX 1404, ALEXANDRIA, VA, 22313-1404, US

(73) Assignee: K. D. Nyegaard, Poway, CA (US)

(21) Appl. No.: 11/851,480

(22) Filed: Sep. 7, 2007

Related U.S. Application Data
(60) Provisional application No. 60/824,949, filed on Sep. 8, 2006.

(51) Int. Cl. G06Q 10/00

(52) U.S. Cl. 705/10

(57) ABSTRACT

The disclosure allows employers, jobseekers and workforce professionals to access and compare information on different jobs, job families, locations and industries in terms of relative supply and demand forces as indicated in a normalized Price/Earnings Ratio. The disclosure captures and measures current prices offered in the market for jobs in locations, industries and time frames and compares such prices with benchmark salaries about what employers have paid all employers in the same jobs, industries and locations. The disclosure normalizes this measure allowing users a common measure to see the relative difference between what all workers have typically been paid in a certain occupation, location and/or industry and what new hires are being offered currently for the same jobs in the same occupation, location and/or industry and thereby getting an indication as to the current level of supply and demand forces for the chosen occupation, location and/or industry.

### CROSS-REFERENCE TO RELATED APPLICATIONS

This application claims priority under 35 U.S.C. §119 to U.S. Provisional Application Ser. No. 60/824,949, filed Sep. 8, 2006, the disclosure of which is incorporated herein by reference.

### FIELD OF THE INVENTION

The invention provides methods and systems to determine supply/demand inequities for job positions in various occupations, industries and/or geographic locations.

### BACKGROUND

The Workforce Exchange system is “in-efficient” compared to commodity and stock exchanges, because buyers (employers) and sellers (job applicants) do not have access to relevant and current information about price and supply and demand factors allowing for an informed choice relating to a specific job offer and subsequent hiring/acceptance decision. As a result, employers often make less than ideal hiring decisions considering their needs and jobseekers can find themselves in less than ideal jobs considering their skills.

### SUMMARY

A solution offered by the disclosure comprises a common measure of relative supply and demand factors by determining the difference between current salary offered for hires in the market for an occupation (e.g., Price) and a base line salary that is common for all workers in the same market/occupation (e.g., Earnings) and comparing it to an intrinsic, Standard Price/Earnings differential between the two measures. The difference between the current and standard ratios as described in this invention provides a common, relative measure indicative of the underlying supply/demand factors regardless of short-term “price” swings.

The disclosure provides a method for determining the relative supply/demand inequities in a job market, comprising: providing a source database, wherein the source database comprises benchmark median and average compensation paid to all workers and classified by an occupational classification code, a geographical location and/or an industry; obtaining a plurality of current job orders; extracting information from each of the plurality of current job orders comprising one or more pieces of information selected from the group consisting of company name, address, job title, benefits offered, salary offered and type of job, term of job, hours of job, and requirements in terms of experience and education; identifying keywords in the extracted information and comparing it to a database of label information used for occupational classification equivalent to the classification used for the benchmark salaries; and providing a job order occupational code to each of the plurality of current job orders based upon the comparison to the label data defined above; translating all salary offered information to annual equivalents; running a cross check to determine that the resulting salary offered information fall within a defined, valid range; matching a set of current job orders to the occupational classification code in the source database using the job order occupational code; calculating an aggregate median and average salary offered for each occupational code by geographical area and industry; calculating a raw Price/Earnings ratio comprising dividing the aggregated median and average salaries by the corresponding median and average benchmark earnings; and outputting a raw Price/Earnings ratio. In one aspect, the job market is for specific occupations or groups of occupations. In another aspect, the job market is in specific geographical locations or regions. In a further aspect, the method is defined by a time frame. In yet another aspect, the benchmark median and average salaries comprise salaries information for all workers in a given occupation and geographical area. In another aspect, the source database comprises survey data produced annually by the Bureau of Labor Statistics. In a further aspect, the term of a job comprises temporary or permanent and the hours of the job comprise full-time, part-time or contract. The information regarding the plurality of current job orders can be obtained from the internet and/or in classified advertisements. The method can further include updating a database with the aggregate median and average salary. The method can further include calculating a national mean and average salary offered for each occupational classification for a given base year. In one aspect, the national mean and average is output as a typical offering price for each occupational classification for a time period. The method can further include providing an intrinsic, Standard Price/Earnings ratio comprising dividing the typical offering price by the mean and median compensation offered to all workers comprising a database of such benchmark compensation data. The method can further include multiplying the raw Price Earnings Ratios by the intrinsic, Standard Price/Earnings ratio to obtain a “normalized Price/Earnings” ratio. The foregoing methods can be implemented by a computer. For example, the method can be implemented by a computer for displaying Price/Earnings comprising: receiving information from a user indicative of a type of occupation or group of occupations, a geographical region, an industry or industries and a time frame or time frames; using said input to retrieve the appropriate information using the computer implemented method described herein; and presenting the resulting information to the user.

The disclosure also provides a method implemented by a computer for displaying occupational inequities comprising: obtaining from a source database, benchmark median and average compensation paid to all workers and classified by an occupational classification code, a geographical location and/or an industry; obtaining a plurality of current job orders; extracting information from each of the plurality of current job orders comprising one or more pieces of information selected from the group consisting of company name, address, job title, benefits offered, salary offered and type of job, term of job, hours of job, and requirements in terms of experience and education; identifying keywords in the extracted information and comparing it to a database of label information used for occupational classification equivalent to the classification used for the benchmark salaries; and providing a job order occupational code to each of the plurality of current job orders based upon the comparison to the label data defined above; translating all salary offered information to annual equivalents; running a cross check to determine that the resulting salary offered information fall within defined range; matching a set of current job orders to the occupational classification code in the source database using the job order occupational code; calculating an aggregate median and average salary for each occupational code by geographical area; calculating a raw Price/Earnings ratio comprising dividing the aggregated median and average salaries by the corresponding median and average benchmark earnings; and outputting a raw Price/Earnings ratio. The computer implemented method can further include outputting an intrinsic, Standard Price/Earnings ratio comprising dividing the typical offering price by the mean and median compensation offered to all workers comprising a database of such benchmark compensation data. The computer implemented method can include outputting a normalized Price/Earnings ratio comprising multiplying the raw Price Earnings Ratios by the intrinsic, Standard Price/Earnings ratio to obtain a “normalized Price/Earnings” ratio. The output information can include, for example, graphical presentations of various time series graphs depicting moving averages of salaries offered versus benchmark salaries, raw price earnings ratios, normalized price earnings ratios, deltas of price earnings ratios, by regions such as city, state, major region and nationally, by specific occupation, groups of occupations, industry and/or size of firm. In one aspect, the output information comprises ranked lists of occupations, location and/or industries, said rankings being based upon the normalized P/E ratios and indicating a supply/demand rating

The disclosure also provides a computer readable medium comprising instructions to cause a computer to carry out the methods of the disclosure.

### DESCRIPTION OF DRAWINGS

FIG. 1 is a flow chart depicting methods of the disclosure.

### DETAILED DESCRIPTION

As used herein and in the appended claims, the singular forms “a,” “and,” and “the” include plural referents unless the context clearly dictates otherwise. Thus, for example, reference to “a salary” includes a plurality of such salaries and reference to “the occupation” includes reference to one or more occupations known to those skilled in the art, and so forth.

Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices and materials are described herein.

The publications discussed above and throughout the text are provided solely for their disclosure prior to the filing date of the present application. Nothing herein is to be construed as an admission that the inventors are not entitled to antedate such disclosure by virtue of prior disclosure.

The reference to Price/Earnings (P/E) herein is not to be confused with the term Price/Earnings as used for financial stocks to gauge potential future earnings power. As with stocks, the Price/Earnings ratio used herein provides a common measure that allows for relative “apples-to-apples” comparison, but unlike the P/E ratio for stocks, it is used to uncover perceived short-to-medium term supply/demand inequities for specific jobs in specific locations and geographies.

Three terms, Raw Price/Earnings, Standard Price Earnings and Normalized Price/Earnings are referred to throughout this text. Raw Price Earnings includes, for example, the measure of a difference between what all workers are reported to be making in a given base year and occupation/market and what employers are currently offering applicants in the same market/occupation. A Standard Price/Earnings includes, for example, an intrinsic difference between what all workers are typically paid in a given occupation and what new hires are typically offered for the same occupation. A Normalized Price/Earnings Ratio refers to a Raw Price/Earnings ratio multiplied by a Standard Price/Earnings ratio.

With the approximately 60 million hiring transactions made in the United States each year, even a marginal improvement in the efficiency of the market would have a considerable effect on the economy, not to mention the social welfare of its more than 150 million workers and their families. With the advent of large aggregations of electronic job orders posted on the World Wide Web, combined with increased computing power, it has now become practical and economical to extract current “price” information for specific jobs.

Economic theory and practice dictate that supply/demand factors are the primary cause of price fluctuations for a given commodity. However, a simple measure of price movement for a given job does not in and of itself provide an adequate picture of underlying supply and demand factors critical to making an informed decision. For example, an occupation that is in chronic under-supply may show a short term “price” drop but still have a significantly higher supply deficiency than another occupation in chronic over-supply that show a “price” up-tick. A solution to this problem is to develop a common measure that makes it possible to compare occupational “price” information on a relative basis. Such a common measure would make it significantly easier for a company to determine what to offer and where to look for required talent, for an economic development agency to determine which local industries to promote to, which outside population groups to recruit from and which educational programs to support, or for a jobseeker to decide on a career or location change, how much they can expect to make and how flexible they should be in the negotiations. According to Adam Smith, the “father” of capitalism, equal access for buyers and sellers to relevant information relating to a transaction, is the corner stone of an efficient market. The common measure described herein thus has the potential to provide a significant improvement in the efficiency of the workforce exchange system resulting reduced time-to-hire and unemployment periods, better and more satisfactory matches between jobseekers and employers and lower turn-over ratios in much the same way that Multiple Listing Service significantly improved the efficiency of the real estate exchange system.

Every occupation has an intrinsic difference between the compensation every worker in a specific occupation earns (earnings) and what new-hires are offered (price). In occupations requiring little specific experience, this Standard Price/Earnings ratio tends to be low, such as helpers and counter clerks, whereas occupations where specific experience is critical, such as financial managers, the Standard ratio is high. Everything else being equal, in a neutral supply/demand market (where supply and demand is in equilibrium) this ratio remains stable. If the existing supply cannot meet the demand, the price paid to new-hires will tend to move up and impact this ratio. Conversely, if there is an over-supply, the price paid to new hires will tend to move down. Thus, if an occupation is “trading” at a below the intrinsic Standard Price/Earnings ratio, it means that employers are currently offering less than the typical differential between new hires and existing employees which is an indication that the perceived supply is currently greater than current demand. Conversely, if an occupation is “trading” above the intrinsic Standard P/E ratio, it means that employers are currently paying more than the typical differential between new hires and existing employees, indicating a currently perceived under-supply for the occupation in question. For example, if the Standard P/E ratio for Bakers is 0.92 and 0.65 for Financial Managers and the current, Raw P/E ratio in San Francisco is 0.90 for Bakers and 0.75 for Financial Managers, then the Normalized P/E ratios are calculated by multiplying the Raw P/E ratio by the Standard P/E ratio arriving at 0.98 and 1.15 respectively. This would indicate the current perceived supply shortage for Financial Managers in San Francisco is greater than it is for Bakers even though Bakers have a higher, Raw P/E ratio. A recent market example includes software developers who as new hires previous to the dot.com implosion were being offered significantly higher salaries than existing employees only to see salary offerings fall significantly below that of existing employees after 2001.

The methods described herein to determine occupational supply and demand forces, avoids the quagmire and expense of arguing and interpreting causes, formulating and fine-tuning ever-changing ratios (which require “back” adjustments) and cleaning up and linking array of support data. In addition, the method as described herein, can be updated in short intervals providing near real-time information not available with current methods.

The method and index provided by the disclosure are flexible in that they can produce information for a local area, an industry, a region or nationally and for a given occupation or cluster of occupations.

By plotting the salary offerings and resulting P/E ratios on a time series, it becomes possible to observe a trend which is a further indication as to the acuity and severity of the underlying supply/demand inequities.

In as much as the Normalized Price/Earnings Ratio puts all occupations on par regardless of location or type of occupation, it makes it possible to easily compare divergent occupations, local areas or regions as well as industries. This, in turn, makes it significantly easier for a company to determine which area will be the easiest to find required talent, what to offer and how flexible to be, for an economic development agency to determine which industries to promote to, which outside population groups to promote to and which educational programs to support, or for a jobseeker to decide on a career or location change, what to expect in terms of compensation range and how difficult or easy it will be to find suitable employment.

The disclosure includes, in one aspect, the automated ability to summarize and present the results of a profile search in a format that is useful for compensation comparisons and job market fluctuations. A chart or index of the disclosure can include a series of values, such as skills, paired with a series of measures, such as average salary, median salary, standard deviation, and/or price/earnings ratio. A report or index of the disclosure can include a series of charts combined to provide an overall picture and analysis for a user. For instance, consider a report that aims to discover how a user compares with regard to skills and experience in similar jobs. This report incorporates many charts, as defined herein, which are combined into a format that gives a user an analysis and understanding of the results of the user's search goal. The disclosure herein allows for a more targeted and relevant compensation information and job market trends by focusing in an automated, scalable fashion, on attributes that are unique to a user, in addition to the attributes that are most common to all users.

Creating a relevant and usable measure of Normalized Price/Earnings for occupations require a valid measure of current price offered by occupation, location and industry, a valid measure of what all employees in the same occupation, location and industry typically make and the intrinsic, historical differential between the two.

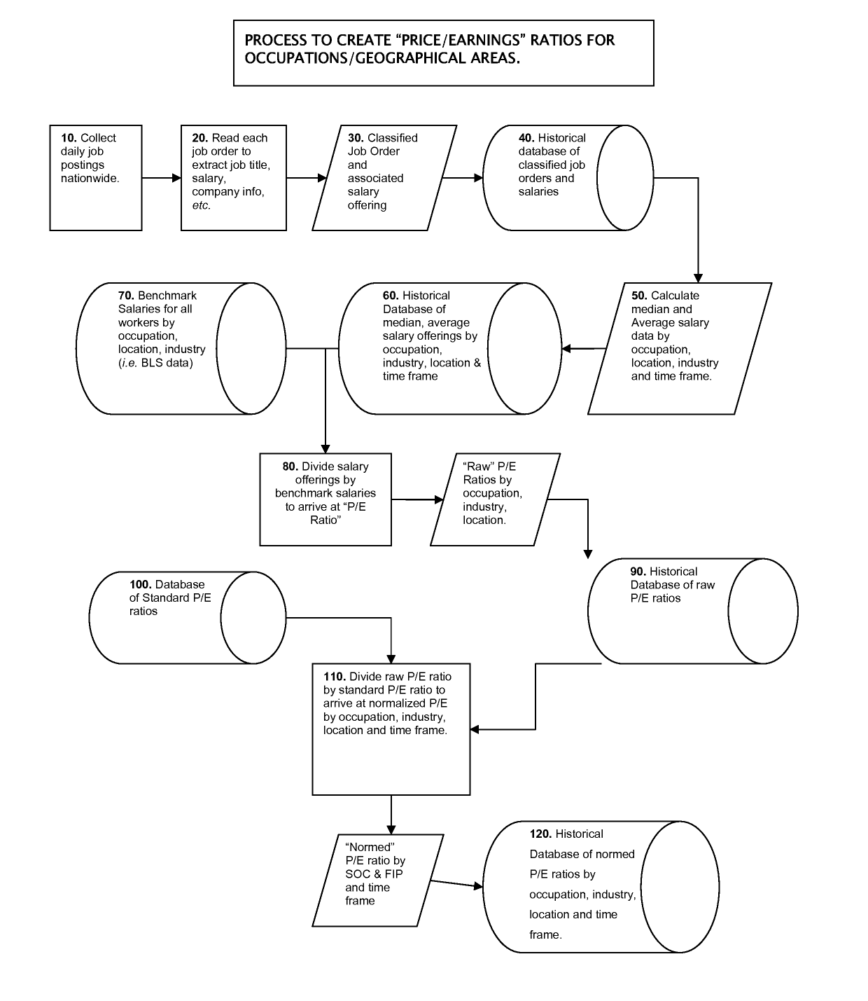

Referring to FIG. 1 there is shown a general process of the disclosure. New job orders/postings are collected daily 10. Methods for collecting job posting can include, for example, downloading job posting information from the World Wide Web, scanning classified print advertisements, etc. Each job order is read to extract a salary range offered (“salary offering”), company information, location and type of job 20. Using keywords and label data, a job order is classified 30 according to a standard occupational taxonomy such as the “Standard Occupational Classification” system as promulgated by the Department of Labor. Likewise, a zip code or city/state combination can be extracted to determine which Metropolitan Statistical Area the job order belongs to. The company information can be compared to a database of companies (such as InfoUSA or Dunn & Bradstreet) to add an industrial code and size identifier to the job order. Duplicate job orders can be removed by comparing job title, date posted and company name/location.

The resulting acquired data sets from 30 are stored to a database 40 such that the information can be retrieved by occupational classification, type, location, industry, company size and/or date. Salary offering data is processed with regular intervals using statistical algorithms to eliminate statistical outliers in order to arrive at valid means and medians of the recorded salary offerings by occupation, location and industry 50.

The mean and median salary offering results from 50 are stored to a database 60 in such a way that information can be retrieved by occupational classification, type, location, industry, company size and/or date. A source database of benchmark Earnings (e.g., what all employees in a certain occupation, industry, and/or location have been recorded as making), classified with the same occupational taxonomy, industry, and/or location identifiers as used to classify the processed salary offerings from 30 above, is accessed to find the equivalent occupation, industry, and/or location 70.

The salary offerings from 30 is divided by the equivalent Earnings record retrieved from the source database described 70, resulting in a Raw Price/Earnings ratio for the specific occupation, industry, and/or location 80. The Raw Price/Earnings ratio can be stored to a database 90. A source database of Standard Price/Earnings ratios, also classified in the same way as the recorded salary offerings in 30 above is accessed to find the equivalent Standard P/E ratio 100.

The Raw P/E ratio from 80 can be multiplied by the Standard P/E ratio from 100 to arrive at a Normalized P/E ratio for the specific occupation/industry/location 110. The results are stored in a database that makes it possible to retrieve the results according to the combinations defined in 70 above 120.

As described above, P/E ratio for occupations is a measure of the difference between what all employees typically have been paid in a specific occupation and what employers are currently willing to pay new hires for the same occupation. The ratio can be presented, for example, in two forms: (a) A “Raw” P/E ratio which is a measure of the current market offering for a given occupation/location divided by a standard measure of benchmark earnings for the same occupation/location; and (b) A “Normalized” P/E ratio that allows the reader to easily compare two different occupations, groups of occupations and/or locations.

P/E ratios for occupations can be calculated for a variety of combinations, such as for a specific occupation, a cluster of occupations, an industry based upon typical occupations for such an industry, for a geographic location or region as well as size groups of companies or any combination of the above. In some aspect, the information is created based upon a time period.

Graph plots can include a variety of measures including, but not limited to, 10%, 25%, 50%, 75% and 90% means and medians and include reliability measures such standard deviation and relative standard error.

For example, the following can be used to calculate the ratios on a regular basis. A source of median and average benchmark earnings for specific occupations in specific locations and time frames is accessed to obtain earnings information 70. This embodiment uses annual Compensation Survey data produced by the Bureau of Labor Statistics (BLS). Occupations are reported by Standard Occupational Classification Code (SOC), by NAICS code and by Region, State and Metropolitan Statistical Area (MSA). A database of current salary offerings is created from job orders from a variety of sources such as America's Job Exchange™, Monster™, Careerbuilder™, and the like 10. Individual job orders are read to extract salary offered, company information, location and type of job 20. The job order is classified according to a standard occupational taxonomy compatible with a source database. Likewise, a zip code or city/state combination is extracted to determine which Metropolitan Statistical Area the job order belongs to. The company information is compared to a database of companies (such as InfoUSA or Dunn & Bradstreet) to add an industrial code and size identifier to the job order. Salary offerings are then processed with regular intervals using statistical algorithms to eliminate statistical outliers in order to arrive at valid means and medians of the recorded salary offerings by occupation, location and industry. The resulting means and medians are divided by the corresponding means and medians of a source database of earnings to arrive at a raw Price/Earnings ratio for each occupation/industry/location and added to a database of existing P/E ratios 80. A database of intrinsic occupational Standard P/E ratios 100 can be used to normalize the raw P/E ratio data obtained using the methods of the disclosure. Standard ratios can be calculated 110 using a baseline year (e.g., 2005) in which the median and average salaries of all collected job orders nationwide in the baseline year are divided by the median and average benchmark salaries for all workers in a given occupation on a national basis (from a database source) for the same baseline year. The resulting ratios are designed to account for the intrinsic difference between typical salaries paid to all workers and salaries offered to new hires. The “Raw” P/E ratio described above can then be multiplied by the Standard P/E ratio to arrive at a Normalized ratio making “apples-to-apples” comparisons possible. A Consumer Price index as embodied in the Bureau of Labor Statistics Consumer Price Index for All Urban Consumers can be used to adjust current salary offerings for inflation.

Referring to the process of obtaining job orders 10, current job openings posted by employers can be collected from various sources on an hourly, a daily, a weekly, a monthly or a yearly basis and classified in order to produce a database of current salaries offered by job classification, industry and geographical area. Job orders collected can be cleaned for duplicates by comparing the name the address of the company and the title of the job postings.

On regular intervals, the database of individual job orders are processed and aggregated to produce means and medians for each job classification/industry/geographical area combinations. These numbers are divided by the benchmark numbers from a source database to create a Raw Price/Earnings (P/E) ratio.

Raw ratio numbers are produced by dividing the current mean and median market salaries offered for a given occupation/industry/location and timeframe with the corresponding benchmark salary points such as those produced by the BLS (e.g., a source database). The resulting ratio is then added to the end of an existing series of ratios calculated for previous time frames in order to produce a trend. The resulting ratios can be plotted in a time series for various ranges such as the 25th percentile, the median, the 75th percentile and the average that show the reader the Raw Price/Earnings trend for a given occupation/area.

Multiplying a current, calculated Raw P/E ratio for a specific job classification, industry and location with the Standard P/E ratio, creates a Normalized P/E ratio that is more easily compared to other classifications/industry/locations. This, in turn, makes it possible to determine whether a given occupation/location is currently “trading” at a discount (e.g., below its intrinsic P/E ratio, at Par (e.g., exactly at its intrinsic, or Standard P/E ratio) or at a Premium (e.g., above its intrinsic P/E ratio).

An exemplary process of the disclosure to determining valid occupational “prices” follows. Job postings are obtained from web-based service providers. The job postings are read and categorized as described including the extraction of salary information. A salary point that may have been recorded as $12 per year, is automatically multiplied by 2080 to annualize it. Likewise, a salary point may be given as $24,000 an hour, which is automatically converted to annual. Salary points which can not be determined in this way are discarded. All data points that amount to less than the minimum wage for the location in question or that are more than $500,000 per year are discarded.

For each area/occupation and timeframe, a Standard Deviation can be calculated as follows:

STD=√(ΣS²−((Σ²S/n)/n−1) where S is each salary point and n is the number of observations. The standard deviation is used to calculate the power number indicating how many observations are needed for a certain confidence level given the standard deviation:

Power Number=((STD/√n*c)/(ΣS/n), where STD is the standard deviation, n is the number of observation, S is each salary point and c is the constant associated with a desired confidence level.

A chosen constant for this embodiment is 1.64 which provides an 80% confidence level. This constant was chosen based upon an optimized choice between accuracy and data availability given the data source and analyzed results of the processes. If the power number indicates that there is not enough data for the desired certainty rate, the data is eliminated. Statistical outliers are also removed from the data set. An “outlier” is a data point that is deemed to be invalid. Causes can include wrongly entered salary, that the job was miss-posted to a wrong category, the job was not a posting for the U.S., etc. After removing obvious outliers, the process calculates a lower band and higher band based upon the following formula:

Higher Band=Mean+(STD*2) or the mean of the salary points plus 2 standard deviations.

Lower Band=Mean−(STD*1.5) In other words, the lower band is 1.5 standard deviations from the mean of the data set. A lower STD is used for the lower band because the lower band has a “hard” floor of prevailing minimum wage and research indicates this to be the optimal number to use.

Next the two bands are compared to the standard BLS wage data for the same occupation/industry/area. The 10^{th} percentile median salary and the 90^{th} percentile median salary provided by the BLS are used for this purpose. If the 10^{th} percentile number*0.85 is higher than the Lower Band defined above, then the BLS 10^{th} percentile data*0.85 is used as a Lower Band, otherwise the Lower Band remains the same as defined above. If the BLS 90^{th} percentile salary point*1.1 is greater than the calculated High Band, then the BLS 90^{th} salary point*1.1 is used as the High Band instead. The 0.85 and 1.1 offsets have been selected based upon extensive research that indicates these offsets represent optimal ranges for including as many valid data points as possible.

Historical salary offerings are reviewed on a regular basis and when salary offerings are consistently hitting upper or lower bands, the corresponding band is manually adjusted accordingly. This provides an effective range of 90+% of all typical salaries for a given area/occupation. Each data point that does not fall in the high and low band range is removed from the data set as outliers.

Once the outliers have been removed, the power calculation is applied again and the data is removed if the confidence level indicated by the power number cannot be met from the sample. For the resulting data, the mean is calculated using the following formula:

$$\overline{X} = \frac{1}{n} {\sum }_{i = 1}^{n} {X}_{i}$$

where N is the number of observations for the given occupation, location and industry. The 10%, 25%, 50%, 75% and 90% Medians are calculated for each occupation/industry/location by ranking the associated salary points into an array from low to high and selecting the (n+1)/m)^{th} sample from the array, where n is the number of samples and m is the number required to extract the appropriate array element (i.e. for the 50% median, the number is 2). Since significant fluctuations can occur in the data from month to month, a 3-month moving average is applied to smooth the data.

An approximation of the Relative Standard Error (RSE) is obtained by dividing the standard deviation of the salary estimate (STD(r)) by the estimate itself (r). This quantity is expressed as a percent of the estimate and is calculated as follows: RSE=100×(STD(r)/r). The data is marked accordingly so users have an idea of how reliable the data is. It should be noted that the salary data collected is not a random sample survey, but rather based on large volumes of live data in a loosely classified structure (at least as compared to a carefully stratified random sample), and as such the RSE has less relevance and tends to be significantly higher than would be expected in a simple random sample survey. Some occupations like “Systems Developer” or “Chief Executive” inherently have very high RSEs for the simple reason that the range of skills and experience requirements for the job are extreme.

What makes this index particularly powerful is that all occupations are ranked relative to each other using the normalized ratios, making it ideal for the various “TOP 20” Hot and Cold demand and supply lists. In addition, occupations can be graphically marked along scale from “Sizzling” “Hot”, “Warm” “Neutral” “Chilly” “Cold” and “Freezing.” Both presentation methods are easy to understand and require no degree in statistics to interpret and apply.

A set of time series plots can be produced for each occupational P/E ratio that shows the ratio delta over time for each occupation. The resulting trend will show how fast the supply/demand differential is “cooling” or “warming up.”

A variety of baseline measures and adjustments can be developed using estimations based upon market surveys, industry growth statistics, etc. Such baseline measures could include adjustments for experience level, education level and benefits to mention a few.

The resulting ratios could also be used together with a variety of factors including, but not limited to, aggregating the underlying supply and demand factors such as educational program completers, immigration and emigration, unemployment, occupational cross-overs, import/export data and segregated industry forecasts combined with federal reserve data to produced supply/demand adjustments. For example, if projected completer data from educational institutions show that a large “crop” of graduates in a specific field is about to graduate for a specific location, this information could be used to adjust the projected ratio downwards accordingly. Likewise, if manufacturing inventory levels are decreasing and new orders increasing, the resulting projected economic upswing can be used to adjust related occupational ratios upwards. Another example would be a significant increase in H1B visas which would lead to a downward adjustment for certain high-tech occupations.

The ratios and trends could be used to determine which occupations to allocate training dollars for a local area, just as it could be used by career guidance counselors to guide students towards a specific occupation. Occupations that show a consistent, up-trending P/E ratio is an indication of unmet demand and thus potentially a growth occupation with good opportunities. Likewise, a down trending occupation may indicate a potential over-supply and thus an occupation to steer away from. It could also be used by federal, state and local governments to set priorities in terms of workforce and economic development for the same reasons. It could be used by chambers of commerce and economic development organizations to attract employers and by consulting firms in relocation consultancy and it be used by HR consultants to advise clients regarding compensation structure. For example, if a local area wanted to attract biotech firms and could demonstrate lower P/E ratios for biotech occupations than a competing area, this would indicate that the lower P/E ratio area can more easily meet demand and provide positive information that could help persuade a firm to relocate there instead of an alternate location with higher P/E ratios. In one aspect, the disclosure provides a method and computer implemented method. The method includes determining the relative supply/demand inequities for specific occupations or groups of occupations in specific geographical locations or regions and a defined time frame, comprising: providing a source database, wherein the source database comprises benchmark median and average salaries paid to all workers and classified by an occupational classification code, a geographical location and/or an industry; obtaining a plurality of current job orders; extracting information from each of the plurality of job orders comprising one or more pieces of information selected from the group consisting of company name, address, job title, benefits offered, salary offered and type of job, term of job, hours of job, and requirements in terms of experience and education; identifying keywords in the extracted information and comparing it to a database of label information used for occupational classification equivalent to the classification used for the benchmark salaries; and providing a job order occupational code to each of the plurality of job orders based upon the comparison to the label data defined above; matching each of the plurality of job orders to the occupational classification code in the source database using the job order occupational code; calculating an aggregate median and average salary for each occupational code by geographical area comprising summing all salary offerings from job offerings in a geographical area to obtain a total and dividing the total by the number of job offerings to obtain an aggregated median and average salary value; translating all salaries to annual equivalents and run a cross check to see that the resulting data point fall in reasonable ranges; and calculating a Price/Earnings comprising dividing the aggregated median and average salaries as defined above by the corresponding median and average benchmark earnings; and outputting the Price/Earnings ratio.

The various techniques, methods, and aspects of the disclosure described above can be implemented in part or in whole using computer-based systems and methods. Additionally, computer-based systems and methods can be used to augment or enhance the functionality described above, increase the speed at which the functions can be performed, and provide additional features and aspects as a part of or in addition to those of the disclosure described elsewhere in this document. Various computer-based systems, methods and implementations in accordance with the above-described technology are presented below.

An apparatus of the disclosure may include the use of the methods of the disclosure in conjunction with any of the computer-based systems described herein. The computer-based system may include the means for inputting data either manually or automatically. The system can include devices for scanning the array, or otherwise inputting data about the array, digitizing the image, storing data, processing the data according to the methods described herein, outputting data, or any one of these functions. Any or all of these functions may be automated.

The processor-based system can include a main memory, preferably random access memory (RAM), and can also include a secondary memory. The secondary memory can include, for example, a hard disk drive and/or a removable storage drive, representing a floppy disk drive, a magnetic tape drive, an optical disk drive, etc. The removable storage drive reads from and/or writes to a removable storage medium. Removable storage media represents a floppy disk magnetic tape, optical disk, etc., which is read by and written to removable storage drive. As will be appreciated, the removable storage media includes a computer usable storage medium having stored therein computer software and/or data.

In alternative embodiments, secondary memory may include other similar means for allowing computer programs or other instructions to be loaded into a computer system. Such means can include, for example, a removable storage unit and an interface. Examples of such can include a program cartridge and cartridge interface (such as the found in video game devices), a movable memory chip (such as an EPROM, or PROM) and associated socket, and other removable storage units and interfaces which allow software and data to be transferred from the removable storage unit to the computer system.

The computer system can also include a communications interface. Communications interfaces allow software and data to be transferred between computer system and external devices. Examples of communications interfaces can include a modem, a network interface (such as, for example, an Ethernet card), a communications port, a PCMCIA slot and card, etc. Software and data transferred via a communications interface are in the form of signals which can be electronic, electromagnetic, optical or other signals capable of being received by a communications interface. These signals are provided to a communications interface via a channel capable of carrying signals and can be implemented using a wireless medium, wire or cable, fiber optics or other communications medium. Some examples of a channel can include a phone line, a cellular phone link, an RF link, a network interface, and other communications channels.

In this document, the terms “computer program medium” and “computer usable medium” are used to generally refer to media such as a removable storage device, a disk capable of installation in a disk drive, and signals on a channel. These computer program products are means for providing software or program instructions to a computer system.

Computer programs (also called computer control logic) are stored in main memory and/or secondary memory. Computer programs can also be received via a communications interface. Such computer programs, when executed, enable the computer system to perform the features of the present disclosure as discussed herein. In particular, the computer programs, when executed, enable the processor to perform the features of the present disclosure. Accordingly, such computer programs represent controllers of the computer system.

In an embodiment where the elements are implemented using software, the software may be stored in, or transmitted via, a computer program product and loaded into a computer system using a removable storage drive, hard drive or communications interface. The control logic (software), when executed by the processor, causes the processor to perform the functions of the disclosure as described herein.

In another embodiment, the elements are implemented primarily in hardware using, for example, hardware components such as PALs, application specific integrated circuits (ASICs) or other hardware components. Implementation of a hardware state machine so as to perform the functions described herein will be apparent to persons skilled in the relevant art(s). In yet another embodiment, elements are implanted using a combination of both hardware and software.

In another embodiment, the computer-based methods can be accessed or implemented over the World Wide Web by providing access via a Web Page to the methods of the present disclosure.

What is claimed:

1. A method for determining the relative supply/demand inequities in a job market, comprising:
providing a source database, wherein the source database comprises benchmark median and average compensation paid to all workers and classified by an occupational classification code, a geographical location and/or an industry;
obtaining a plurality of current job orders;
extracting information from each of the plurality of current job orders comprising one or more pieces of information selected from the group consisting of company name, address, job title, benefits offered, salary offered and type of job, term of job, hours of job, and requirements in terms of experience and education;
identifying keywords in the extracted information and comparing it to a database of label information used for occupational classification equivalent to the classification used for the benchmark salaries; and
providing a job order occupational code to each of the plurality of current job orders based upon the comparison to the label data defined above;
translating all salary offered information to annual equivalents;
running a cross check to determine that the resulting salary offered information fall within a defined, valid range;
matching a set of current job orders to the occupational classification code in the source database using the job order occupational code;
calculating an aggregate median and average salary offered for each occupational code by geographical area and industry;
calculating a raw Price/Earnings ratio comprising dividing the aggregated median and average salaries by the corresponding median and average benchmark earnings; and
outputting a raw Price/Earnings ratio.

2. The method of claim 1, wherein the job market is for specific occupations or groups of occupations.

3. The method of claim 1, wherein the job market is in specific geographical locations or regions.

4. The method of claim 1, wherein the method is defined by a time frame.

5. The method of claim 1, wherein the benchmark median and average salaries comprise salaries information for all workers in a given occupation and geographical area.

6. The method of claim 1, wherein the source database comprises survey data produced annually by the Bureau of Labor Statistics.

7. The method of claim 1, wherein the term of a job comprises temporary or permanent.

8. The method of claim 1, wherein the hours of the job comprise full-time, part-time or contract.

9. The method of claim 1, wherein the plurality of current job orders is obtained from the internet and/or in classified advertisements.

10. The method of claim 1, further comprising updating a database with the aggregate median and average salary.

11. The method of claim 1, further comprising calculating a national mean and average salary offered for each occupational classification for a given base year.

12. The method of claim 11, wherein the national mean and average is output as a typical offering price for each occupational classification for a time period.

13. The method of claim 12, further comprising providing an intrinsic, Standard Price/Earnings ratio comprising dividing the typical offering price by the mean and median compensation offered to all workers comprising a database of such benchmark compensation data.

14. The method of claim 13, further comprising multiplying the raw Price Earnings Ratios by the intrinsic, Standard Price/Earnings ratio to obtain a “normalized Price/Earnings” ratio.

15. The method of claim 1, further comprising
receiving information from a user indicative of a type of occupation or group of occupations, a geographical region, an industry or industries and a time frame or time frames of interest;
retrieving information; and
presenting the resulting information to the user.

16. A method implemented by a computer for displaying occupational inequities comprising:
obtaining from a source database, benchmark median and average compensation paid to all workers and classified by an occupational classification code, a geographical location and/or an industry;
obtaining a plurality of current job orders;
extracting information from each of the plurality of current job orders comprising one or more pieces of information selected from the group consisting of company name, address, job title, benefits offered, salary offered and type of job, term of job, hours of job, and requirements in terms of experience and education;
identifying keywords in the extracted information and comparing it to a database of label information used for occupational classification equivalent to the classification used for the benchmark salaries; and
providing a job order occupational code to each of the plurality of current job orders based upon the comparison to the label data defined above;
translating all salary offered information to annual equivalents;
running a cross check to determine that the resulting salary offered information fall within defined range;
matching a set of current job orders to the occupational classification code in the source database using the job order occupational code;
calculating an aggregate median and average salary for each occupational code by geographical area;
calculating a raw Price/Earnings ratio comprising dividing the aggregated median and average salaries by the corresponding median and average benchmark earnings; and
outputting a raw Price/Earnings ratio.

17. The method of claim 16, further comprising outputting an intrinsic, Standard Price/Earnings ratio comprising dividing the typical offering price by the mean and median compensation offered to all workers comprising a database of such benchmark compensation data.

18. The method of claim 17, further comprising outputting a normalized Price/Earnings ratio comprising multiplying the raw Price Earnings Ratios by the intrinsic, Standard Price/Earnings ratio to obtain a “normalized Price/Earnings” ratio.

19. The method of claim 17, wherein the output information comprises graphical presentations of various time series graphs depicting moving averages of salaries offered versus benchmark salaries, raw price earnings ratios, normalized price earnings ratios, deltas of price earnings ratios, by regions such as city, state, major region and nationally, by specific occupation, groups of occupations, industry, size of firm; and/or ranked lists of occupations, location and/or industries, said rankings being based upon the normalized P/E ratios and indicating a supply/demand rating.

20. A computer readable medium comprising instructions to cause a computer to carry out the method of claim 1.
